(19) United States
(12) Patent Application Publication
(10) Pub. No.: US 2010/0237606 A1
(43) Pub. Date: Sep. 23, 2010

(54) END SEAL FOR PIPELINE

(75) Inventors: Christopher J. Lazzara, Palm Beach Shores, FL (US); Richard J. Lazzara, Palm Beach Gardens, FL (US); James R. Schwarz, West Palm Beach, FL (US)

Correspondence Address: NIXON PEABODY, LLP, 300 S. Riverside Plaza, 16th Floor, CHICAGO, IL, 60606-6613, US

(73) Assignee: Neptune Research Inc., Lake Park, FL (US)

(21) Appl. No.: 12/726,822

(22) Filed: Mar. 18, 2010

Related U.S. Application Data
(60) Provisional application No. 61/162,077, filed on Mar. 20, 2009.

(51) Int. Cl. F16L 7/02

(52) U.S. Cl. 285/123.12

(57) ABSTRACT

End seals, end seal kits, and methods for sealing the space between an outer casing and an inner pipe, which extends through the outer casing, are provided herein. The end seal may include a frustoconical seal member configured to seal the space at one end of the outer casing. A composite wrap covers the seal member. The kit includes a deformable sealing putty and a flexible wrap. The method includes: applying a deformable sealing putty to the outer casing and inner pipe; forming the sealing putty into a fluid tight seal, the seal having a hollow body with an annular segment disposed within the outer casing, and a frustoconical segment extending coaxially from the annular segment outside of the outer casing; wrapping a flexible fiberglass composite wrap around the frustoconical segment of the seal; and curing the fiberglass composite wrap.

### CROSS-REFERENCE TO RELATED APPLICATION

This application claims the benefit of and priority to U.S. Provisional Patent Application No. 61/162,077, filed on Mar. 20, 2009, which is incorporated herein by reference in its entirety.

### TECHNICAL FIELD

The present invention relates generally to piping and pipelines, and more particularly to end seals for pipeline assemblies with an outer casing pipe that circumscribes one or more inner transmission pipelines.

### BACKGROUND OF THE INVENTION

Conduit assemblies, such as pipelines and hydraulic circuits, are used to transport an assortment of fluids, such as water, oil, various natural and synthetic gases, sewage, slurry, hazardous materials, and the like. Modern day fluid pipelines are formed from a variety of materials, including concrete, plastic (e.g., polyvinyl chloride, polyethylene, etc.), and various metallic materials, such as iron, copper, and steel. The outer surface of metal pipes, when used in an outdoor application, is typically provided with a corrosion resistant coating.

In laying pipelines, many of the individual pipes are buried underground. Pipelines often pass under roadways, railroads, and other similar heavily loaded areas. To protect sections of pipeline that are buried underground, in particular those sections which pass under heavily loaded areas, and to avoid inadvertent leakage of gas or liquid from the pipeline, a rigid outer casing is generally provided around the buried sections of pipeline. The section of pipeline extending through the rigid outer casing is commonly referred to as the inner carrier pipe or “transmission pipeline”.

In many applications, end seals are provided at each end of the outer casing to prevent moisture, water, and contaminants from entering the annular space between the inner carrier pipe and the outer casing. For example, one prior seal arrangement consists of a bipartite, laminar metal end-cap, where the two pieces are assembled around the inner transmission pipeline, welded together to form a unitary body, and thereafter welded to the transmission pipeline and the outer casing. Another prior approach is to wrap rubber sheet material around the end of the outer casing, and thereafter fastening the opposite ends of the rubber sheet to the outer casing and inner carrier pipe with annular band clamps. Both of the aforementioned approaches have proven to be time consuming and costly, and have a limited operational life expectancy.

### SUMMARY OF THE INVENTION

According to one exemplary embodiment, an end seal assembly is provided for sealing the space between an outer casing and at least one inner pipe that extends at least partially through the outer casing. The end seal assembly includes a seal member including a putty material configured to seal the space between the outer casing and the at least one inner pipe. The seal member is in sealing communication with, and extends between an exterior surface of the at least one inner pipe and an interior surface of the outer casing. A composite wrap covers at least a portion of the seal member. The composite wrap may include a fiberglass composite material.

According to another exemplary embodiment, an end seal kit is provided for sealing the space between an outer casing pipe and an at least one inner pipe extending at least partially through the outer casing pipe. The end seal kit includes a deformable sealing putty that is configured to extend between and mate with an exterior surface of the at least one inner pipe and an interior surface of the outer casing pipe to thereby create a fluid tight seal. The sealing putty comprises a non-cross-linked synthetic polyolefin. The end seal kit also includes a flexible wrap that is configured to surround the sealing putty. The flexible wrap comprises a continuous filament fiberglass cloth that is impregnated with a resinous pliable-plastic material operable to harden upon exposure to aqueous moisture.

In accordance with yet another exemplary embodiment, a method is presented for sealing the space between an outer casing pipe and at least one inner casing pipe that extends at least partially through the outer casing pipe. The method comprises applying a deformable sealing putty to at least one of the outer casing pipe or the at least one inner pipe. The method also comprises forming the sealing putty into a fluid tight seal that extends between an exterior surface of the inner pipe and an interior surface of the outer casing pipe. The seal has a seal body with an annular segment disposed within the casing pipe, and a frustoconical segment that extends generally coaxial from one side of the annular segment outside of the outer casing pipe. The method further comprises wrapping a flexible composite wrap around the frustoconical segment of the seal, and curing the flexible composite wrap.

The above summary of the invention is not intended to represent each embodiment, or every aspect, of the present invention. The above features and advantages, and other features and advantages of the present invention, will be readily apparent from the following detailed description of the preferred embodiments and best modes for carrying out the present invention when taken in connection with the accompanying drawings and appended claims.

### BRIEF DESCRIPTION OF THE DRAWINGS

FIG. 1A is an elevated side-view illustration of an outer casing with an inner pipe extending therethrough, the outer casing being partially-broken-away to show a seal member of an end seal assembly in accordance with certain embodiments of the present invention;

FIG. 1B is an elevated side-view illustration of the outer casing and inner pipe of FIG. 1A, showing a composite wrap member of the end seal assembly;

FIG. 1C is an elevated partially-broken-away side-view illustration of the end seal assembly from FIGS. 1A and 1B;

FIG. 1D is an elevated side-view illustration of the outer casing and inner pipe of FIG. 1A, partially-broken-away to show a seal member and an alternative backing wall of an end seal assembly in accordance with certain embodiments of the present invention;

FIG. 2 is a perspective-view illustration of an end seal kit in accordance with certain embodiments of the present invention; and

FIG. 3 is a flow chart diagrammatically illustrating a method for sealing a space between an outer casing and an inner pipe at one end of the outer casing pipe in accordance with certain embodiments of the present invention.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DESCRIPTION OF THE EXEMPLARY EMBODIMENTS

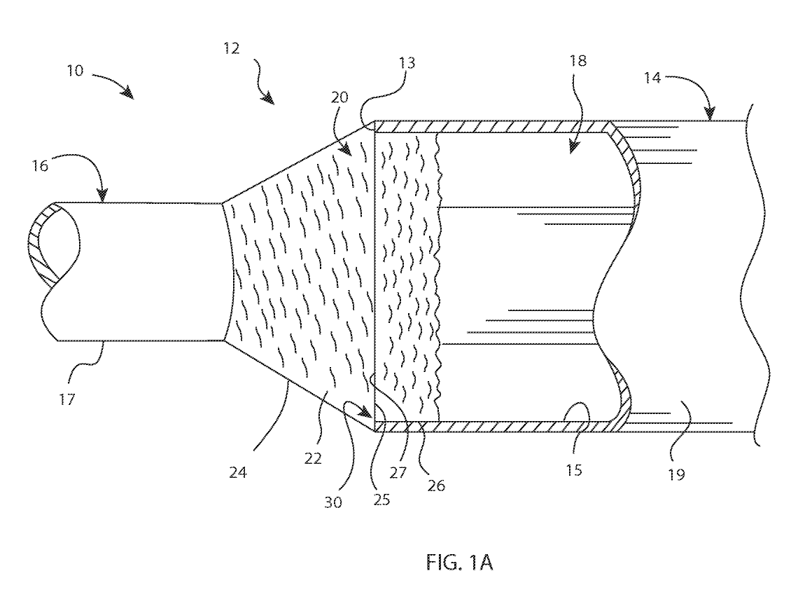

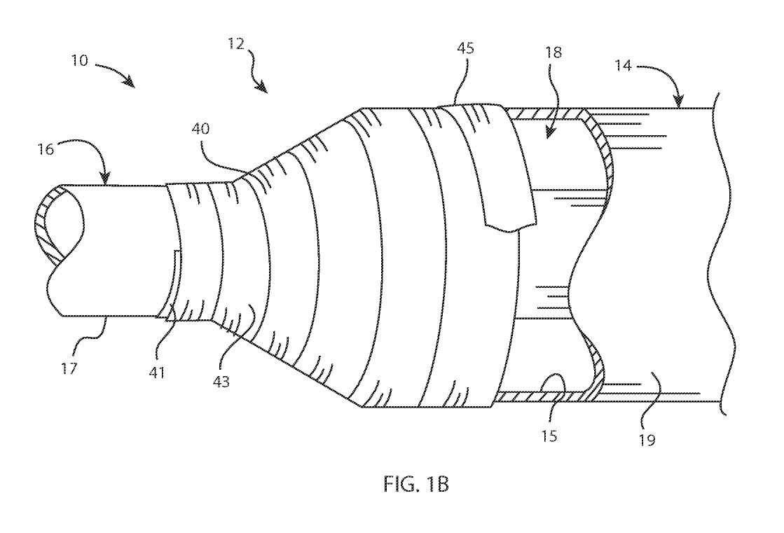

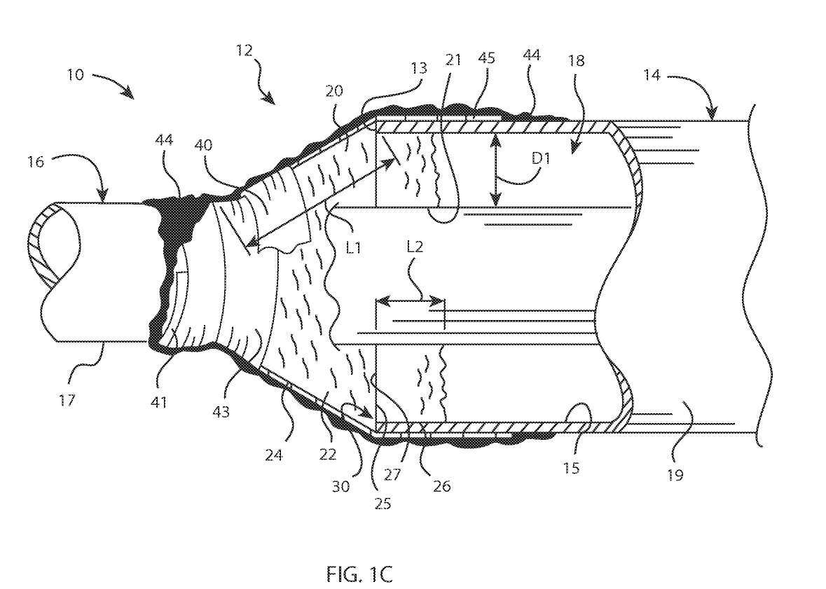

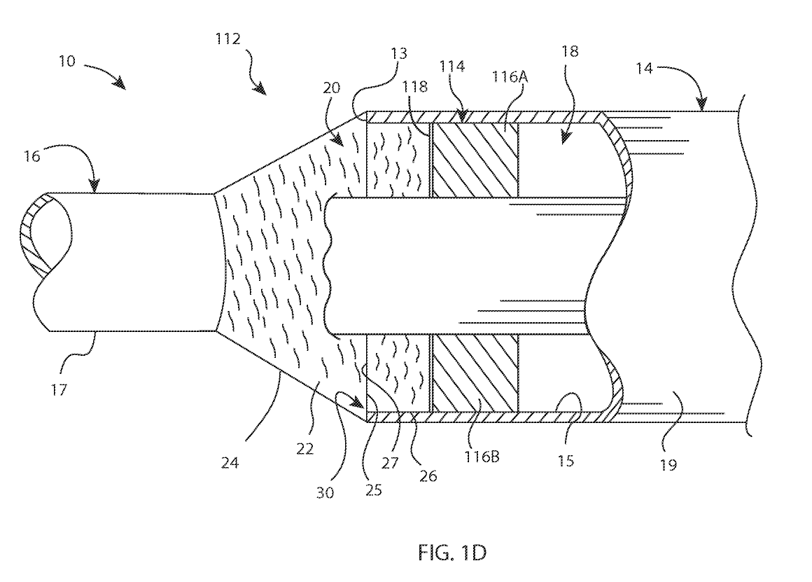

Referring to the drawings, wherein like reference numbers refer to like components throughout the several views, FIGS. 1A-1C illustrate a fluid pipeline assembly, indicated generally at 10, with an end seal assembly in accordance with one embodiment of the present invention, designated generally as 12. The particular pipeline arrangement shown throughout FIGS. 1A-1C is provided merely for exemplary purposes, and should therefore not be considered limiting. By way of example, and not limitation, the fluid pipeline assembly is intended for transporting any of an assortment of fluids, such as water, oil, natural and synthetic gases, sewage, slurry, hazardous materials, etc. However, the present disclosures may be utilized in other pipeline assemblies, such as, for example, those containing fiber optic or electrical cabling. In addition, the drawings presented herein are not to scale and are provided purely for instructional purposes. Thus, the individual and relative dimensions shown in the drawings are not to be considered limiting.

The fluid pipeline assembly 10 includes an outer casing 14 (also referred to herein as “outer casing pipe”). The outer casing 14 is employed to protect that portion of a transmission pipeline 16 (also referred to as “inner pipeline” or “inner pipe”) which extends at least partially through the outer casing 14. The outer casing 14 may be constructed of any feasible material having sufficient strength to withstand, for example, external loads exacted thereon, such as those that exist by reason of a surrounding formation (e.g., when the pipeline assembly is buried underground), as well as any additional loads applied thereto (e.g., by a vehicle driving along an over-passing roadway). In addition, the outer casing 14 may be constructed of an impervious material capable of minimizing or otherwise preventing the seepage of fluids into and out of an annular space, designated generally as 18, between the outer casing 14 and the inner pipe 16 passing therethrough. It is also contemplated that the various embodiments of the present invention be applied to all pipeline assemblies, such as, but certainly not limited to, new constructions and above-ground cased pipe assemblies. It is contemplated that, in certain embodiments, the outer casing and/or the inner pipe are formed, for example, from steel, iron, concrete, or fiber-reinforced plastic (FRP) or combination thereof.

To prevent inadvertent contact between the outer casing 14 and inner pipe 16, the inner pipe 16 may be spaced from the outer casing 14 and retained in place by spacers or runners (neither of which are illustrated herein). To this regard, the outer casing 14 and inner pipe 16 are shown in FIGS. 1A-1C concentrically aligned with one another. However, the inner pipe 16 may be axially offset from the outer casing 14 without departing from the scope and spirit of the present invention. Moreover, although illustrated as cylindrical components, the outer casing 14 and inner pipe 16 may take on other geometric cross-sections (e.g., oval, polygonal) without departing from the scope and spirit of the present invention. Finally, the inner pipe 16 may comprise an array of bundled pipes or conduits that route through the outer casing 14.

In accordance with one embodiment, an end seal assembly 12 is located at either end of the outer casing 14 (only one of which is visible in FIGS. 1A-1C, but an identical mirror-image counterpart may be present at the other end of the outer casing 14). The end seal 12 of this invention closes off a portion of the open end of the outer casing 14, sealing the annular space 18 between the interior surface 15 of the outer casing 14 and the exterior surface 17 of the inner pipe 16. The end seal assembly 12 comprises two primary parts: a seal member 20 and a composite wrap 40.

In the exemplary configuration presented in FIGS. 1A-1C, the seal member 20 includes an elongated hollow body 22 that is concentrically oriented with and circumscribes the inner pipe 16. The seal body 22 can have a frustoconical segment 24 that is adjacent to and coaxial with an integrally-formed hollow annular segment 26. As shown in FIG. 1C, the seal body 22 defines a channel 21 that extends through the annular segment 26 and the frustoconical segment 24. Looking at FIG. 1A, the annular segment 26 of the seal 22 is disposed inside the outer casing 14, pressing against and extending between the exterior surface 17 of the inner pipe 16 and the interior surface 15 of the outer casing 14. The frustoconical segment 24, on the other hand, protrudes from an outward-facing longitudinal face 27 of the annular segment 26, projecting out from the outer casing 14. A base portion 25 of the frustoconical segment 24 presses against the outer rim 13 of the casing pipe 14. It should be recognized that the seal member 20 may be fashioned or formed into alternative shapes that take into account varying cross-sections of the outer casing (e.g., oval, polygonal, polygonal with chamfered edges or rounded edges, etc.)

The frustoconical seal member 20 is configured—e.g., chemically and/or mechanically—to seal one end of the annular space 18 defined by the outer casing 14 and inner pipe 16. For example, the frustoconical seal member 20 shown in FIGS. 1A and 1C can be fabricated from an environmentally resilient, water- and gas-impervious putty material. By way of non-limiting example, the seal member 20 may be fabricated from a non-cross-linked synthetic polyolefin, such as Stopaq® FN 4100, manufactured by Stopaq Europe B.V. In addition, the base 25 of the frustoconical segment 24 cooperates with the outer periphery of the annular segment 26 to create a lip seal 30 that presses against and wraps around the outer edge 13 of the outer casing 14, mechanically sealing the annular space 18 at one end of the outer casing 14.

Referring to FIG. 1C, the frustoconical segment 24 of the seal member 20 has a taper length L1. By way of explanation, and not limitation, the frustoconical segment 24 has partial side cross-section in the form of a substantially right-angled triangle, as best seen in FIG. 1A. The surface of the frustoconical segment 24 has a generatrix, which is defined in this example by the hypotenuse of the triangle. In this example, the taper length L1 is the length of the hypotenuse. The seal member 20 is fabricated such that the taper length L1 of the frustoconical segment 24 is equal to approximately two-times the distance D1 between the interior surface 15 of the outer casing 14 and the exterior surface 17 of the inner pipe 16 (also known as the “gap distance”). For example, if the inner diameter (ID) of the outer casing 14 is sixteen (16) inches (40.64 cm), and the outer diameter (OD) of the inner pipe 16 is twelve (12) inches (30.48 cm), the gap distance is equal to approximately two (2) inches (5.08 cm). In this example, the taper length L1 of the frustoconical segment 24 is approximately four (4) inches (10.16 cm) long.

In addition to the above noted parameters, the annular segment 26 of the seal member 20 has a longitudinal length L2 (also referred to herein as “packing depth”). In this regard, the seal member 20 is formed such that the packing depth L2 of the annular segment 26 is approximately half the taper length L1 of the frustoconical segment 24. For example, if the taper length L1 of the frustoconical segment 24 is four (4) inches (10.16 cm), the packing depth L2 of the annular segment 26 is approximately two (2) inches (5.08 cm).

In the embodiments illustrated in FIGS. 1A-1C, a composite wrap 40 can cover substantially all of the seal member 20. For instance, in FIG. 1B, a first end 41 of the composite wrap 40 is wrapped around a portion of the inner pipe's outer surface 17 adjacent to the seal member 20. An intermediate portion 43 of the composite wrap 40 is wound around the seal member 20 in a generally helical manner, with approximately a 50% overlap. The composite wrap 40 is coiled around the seal member 20 until a second, distal end 45 is wrapped around a portion of the exterior surface 19 of the outer casing 14 adjacent to the open end thereof. Alternatively, the composite wrap 40 may be applied transversely with respect to the pipeline assembly 10, with each layer being placed directly over the previous layer. It is also envisioned that the composite wrap 40 be fabricated as a customized, single-piece sheath that is shaped and sized, for example, to meet the geometric and dimensional requirements of a particular pipeline application.

The composite wrap 40 provides a functional cocoon for the seal member 20, creating a structurally reinforcing, water-tight shield. In one embodiment, the composite wrap 40 is fabricated from a fiberglass composite material, such as, for example, a continuous filament fiberglass cloth that is impregnated with a resinous pliable-plastic material. A composite wrap of this construction can be hardened by exposure to aqueous moisture (e.g., water). One such fiberglass composite wrap is disclosed in commonly assigned U.S. Pat. No. 5,030,493, to Rich, which is incorporated herein by reference in its entirety. In certain embodiments, the composite wrap 40 includes a plurality of layers of fiberglass composite material, preferably in the range of eight (8) or more layers. In some embodiments, the seal member 20 and composite wrap 40 cooperatively create a fluid-tight seal with sufficient integrity and resiliency to withstand a pressure of at least five (5) pounds per square inch (psi) (34.47 kPa), and in some embodiments at least seven (7) pounds per square inch (psi) (48.26 kPa), within the space 18 between the outer casing 14 and inner pipe 16. In an alternative configuration, the composite wrap 40 may comprise a cloth that is impregnated by a resin that is set by UV light, or thermoset (heat), or by mixing one part of the resin with another compound (e.g., a catalyst) causing the resin to set and harden.

In the exemplary embodiment illustrated in FIGS. 1A-1C, the end seal assembly 20 may also include a corrosion resistant topcoat 44 that covers the composite wrap 40 and portions of the seal member 20. For instance, in FIG. 1C, the topcoat 44 is spread over a portion of the inner pipe outer surface 17 adjacent to the seal member 20 using, for example, a brush or putty knife. The topcoat 44 is preferably evenly disseminated over the entire composite wrap 40, and spread over a portion of the exterior surface 19 of the outer casing 14 adjacent to the open end thereof.

FIG. 1D illustrates an end seal assembly 112 that is provided with an optional backing wall 114. In the illustrated example, the backing wall 114 is recessed within the outer casing 14 and circumscribes the inner pipe 14. The backing wall 114 provides a rigid surface against which the seal member 20 may be packed and condensed. The seal member 20 can be compressed against the backing wall 114 and thereby increasing the density and seal strength of the annular segment 26.

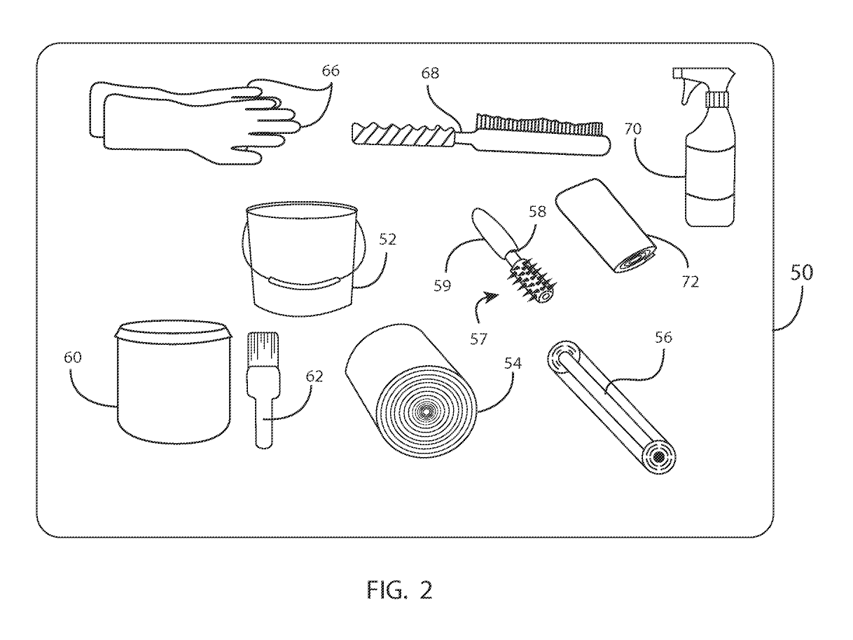

Referring now to FIG. 2, an end seal kit 50 is contemplated for creating a pipeline casing end seal operable for sealing the space between an outer casing and one or more inner transmission pipes that extend at least partially through the outer casing. In other embodiments, the end seal kit 20 may be employed to repair breaches in the casing, such as leaks at seams or through holes resulting, for example, from corrosion or mechanical damage. The end seal kit 50 can include a deformable sealing putty 52, such as the a non-cross-linked synthetic polyolefin putty material described above with respect to FIGS. 1A-1C. The sealing putty 52 is employed to create a fluid-tight seal at one or both of the open ends of an outer casing pipe. The sealing putty 52 of FIG. 2 is a readily manipulable substance that can be applied to the exterior surface of each inner transmission pipe, such as inner pipe 16 of FIGS. 1A-1C, and packed or otherwise amassed within the outer casing pipe, such as outer casing 14 of FIGS. 1A-1C, to extend between and interface with the inner surface of the outer casing pipe and the outer surface of the inner pipe(s). In addition, unlike prior end seal assemblies, a desirable aspect of the sealing putty 52 of FIG. 2 is that it may be fashioned into any of innumerable geometric forms, allowing the operator to customize the shape of the seal member configuration to meet the particular parameters of each pipeline application. For example, the length and size of the seal member segments 24, 26 seen in FIGS. 1A and 1C may be individually or collectively modified depending upon the dimensions of the casing and inner pipe of the pipeline assembly 10.

The end seal kit 50 presented in FIG. 2 also includes a flexible wrap 54 that is adaptable to surround the sealing putty 52, regardless of its final geometric and dimensional characteristics. In one exemplary embodiment, the flexible wrap comprises an elongated continuous filament fiberglass cloth, that is impregnated with a resinous pliable-plastic material operable to harden upon exposure to aqueous moisture, such as the composite wrap 40 of FIGS. 1B and 1C.

In addition to the sealing putty 52 and flexible wrap 54, the end seal kit 50 may further comprise an elastic wrap 56 of sufficient length and width to surround the flexible wrap 54 and preferably at least a portion of the inner pipe(s) and outer casing pipe immediately adjacent to the casing pipe end seal. By way of example, and not limitation, the elastic wrap 56 may comprise a perforable polyethylene film or similar material. When properly applied, the elastic wrap 56 (also referred to as a “compression film”) applies pressure to the flexible wrap 54.

It is contemplated that in certain embodiments the elastic wrap 56 can be configured to evacuate gas that may result from curing of the fiberglass composite wrap 54, and build up underneath the elastic compression wrap 56. In this regard, the end seal kit 50 may be equipped with a perforator tool, shown in one exemplary configuration at 58. The perforator tool 58 of FIG. 2 includes a plurality of spikes, designated generally at 57, that are rotatably mounted to a handle 59. An operator may manipulate the perforator tool 58 using the handle 59, and utilize the spikes 57 to puncture the perforable polyethylene film, and thereby generate a plurality of perforations in the elastic wrap 56. In certain embodiments, the perforator tool 58 may be eliminated from the end seal kit 50; the elastic wrap 56 coming prefabricated with a plurality of perforations.

With continued reference to FIG. 2, the end seal kit 50 can also include a corrosion resistant topcoat 60. Similar to the topcoat 44 utilized in the end seal assembly 12 of FIG. 1C, the sealing putty 52 and flexible wrap 54, once applied to the pipeline assembly, can be coated with one or more layers of topcoat 60 of FIG. 2, e.g., using brush 62, thereby enveloping substantially all of the pipeline casing end seal.

The other components of the end seal kit 50 of FIG. 2 can include protective gloves 66, a pipe roughening device 68, a cleaning solvent 70, and a “shammy” cloth 72. The protective gloves 68 are adapted to be worn by a user in the preparation and application of any materials that may irritate the skin, which may be the case of the flexible fiberglass composite wrap 54 and cleaning solvent 70. The protective gloves 68 are preferably composed of latex, but can be composed of any material that enables the protective gloves 68 to be used for their intended purpose.

The pipe roughening device 24 may be a wire brush (as seen in FIG. 2), or may take on other functional alternatives, such as sandpaper and any other material adapted to clean and roughen a pipe surface. The cleaning solvent 70 can comprise a known solvent with sufficient cleaning capacity to remove hydrocarbon (oily) residue, particulate buildup, and other foreign matter from the outer casing and inner pipe. Such solvents include, but are certainly not limited to, acetone, toluene solvents, alcohol, and the like. A cloth 72 may also be provided for applying the solvent to the pipe surfaces. In the alternative, the cleaning solvent 70 may be replaced with an emulsion, a cleaning compound, or other similar materials and methods which involve a satisfactory cleaning action.

Many of the above indicated components are considered optional, such as the perforator tool 58, protective gloves 66, pipe roughening device 68, cleaning solvent 70, and solvent wipe 72, and are therefore not necessary components of the end seal kit 50. It should also be readily recognized that the constituent parts of the end seal kit 50 may be varied within the scope of the appended claims. In particular, the end seal kit 50 may comprise additional, fewer, or alternative components from those which are illustrated in FIG. 2.

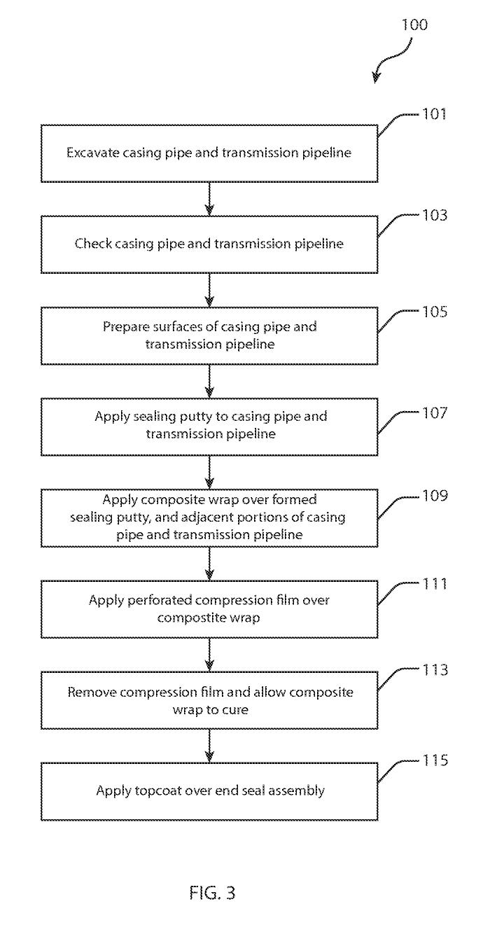

With reference now to the flow chart of FIG. 3, an improved method for sealing a space between an outer casing pipe and one or more inner transmission pipes is generally described at 100 in accordance with certain embodiments. The method or algorithm 100 of FIG. 3 is described herein with respect to the structure illustrated in FIGS. 1A-1C, and the collection presented in FIG. 2. However, the claimed methods of the present invention are not limited to the pipeline assembly 10 of FIGS. 1A-1C or the end seal kit 50 of FIG. 2. Likewise, use of the word “step” or “act” in the specification or claims is not intended to be limiting and should not be considered as limiting.

### Buried Pipeline Applications

In situations where the pipeline assembly 10 is buried prior to formation of the pipeline casing end seal 12, the outer casing 14 and inner pipeline 16 should be excavated sufficiently on both sides, as recited in step 101. Proper safety considerations aside, the pipeline assembly 10 may be considered sufficiently excavated so that the pipes 14, 16 can be initially inspected, and thereafter properly handled during fabrication of the end seal. Accordingly, in step 103, both the outer casing 14 and the inner pipe 16 are checked for any of an array of predetermined deterioration characteristics. Such characteristics may include, but are certainly not limited to, considerable wall loss (i.e., excessive deterioration of a pipe wall), significant pipe contact, inadequate remaining pipe coating, etc. If it is determined that one or more of these characteristics is present, the operator should preferably take appropriate action. Such action may include repairing one or more of the pipes if there is heavy wall loss, or merely coating the pipe if there is minimal wall loss. In addition, if there is significant pipe contact, the operator may dig up the pipeline assembly some additional distance, and reset the pipe to eliminate inadvertent casing-to-pipe contact.

### General Surface Preparation

Prior to fabrication of the pipeline casing end seal, the application surfaces of the outer casing and inner transmission pipe are prepared in step 105 of the embodiment illustrated in FIG. 3. Such preparation may include cleaning both the interior surface 15 of the outer casing 14 and the exterior surface 17 of the transmission pipeline 16 over a predetermined length. For example, the exterior surface 17 of the inner pipe 16 may be cleaned over a total length of 3-3.5 meters (m), including a 1-1.5 m cleaning depth into the outer casing 14, and 1.5-2 m cleaning length extending from the open end of the outer casing 14 Likewise, the interior surface 15 of the outer casing pipe 14 may have the same cleaning depth as the inner pipe outer surface 17—e.g., 1-1.5 m. As another example, the predetermined cleaning length can be defined by the distance between the OD of the inner pipe and inner ID of the outer pipe (i.e., the gap distance). In yet another example, the predetermined cleaning length can be defined as one-half of the gap distance.

Initially, the operator should attempt to remove all foreign matter on the application surfaces of the outer casing and inner transmission pipe. This may include removal of nearly all pipe coatings, mill scale, rust, rust scale, paint, and other foreign matter by the use of abrasives, such as pipe roughening device 68. In certain embodiments, a near-white blast cleaned surface finish can be achieved, wherein which all oil, grease, dirt, mill scale, rust, corrosion products, oxides, paint and other foreign matter has been substantially removed from the surface except for very light shadows, very slight streaks, or slight discolorations caused by rust stain, mill scale oxides, or light, tight residues of paint or coating that may remain.

Subsequently, a solvent wipe, such as cloth 72 of FIG. 2 sprayed with cleaning solvent 70, may be applied over the application surfaces to remove any oil or old casing wax. Since the material of the cleaning solvent 70 may be an irritant, an operator may choose to use the supplied protective gloves 66 prior to the application of the solvent wipe. It is desirable that in step 105 of FIG. 3, detrimental foreign matter such as oil, grease, dirt, soil, salts, drawing and cutting compounds, and other contaminants from the pipe application surfaces be removed. Care may be taken to remove all particulates and oily matter from the application surfaces. For example, traces of hydrocarbon (oily) residue may impair surface adhesion.

Once the application surfaces have been adequately cleaned, an anchor pattern can be fashioned into the interior surface 15 of the outer casing pipe 14 and the exterior surface 17 of inner pipe prior 16. A high-pressure water blast, desirably in the range of approximately 20 to 48 MPa (3,000 to 7,000 psi), may be used to create the anchor pattern. The recommended surface preparation of the casing pipe 14 and transmission pipeline 16 is an anchor pattern with a 0.0254-0.1016 mm (1-4 mils) etching depth.

### Backing Wall

In some embodiments, a rigid or semi-rigid backing wall 114 can be then constructed inside of the outer casing 14, as illustrated in FIG. 1D. As explained above, the backing wall 114 generates a rigid surface against which the seal member 20 is packed and compressed. According to one exemplary configuration, the backing wall 114 is fabricated from a number of flexible, foam-like (e.g., sponge) inserts 116A and 116B (collectively designated as 116). Each insert 116 may be impregnated with a resinous substance that hardens when exposed to aqueous moisture. Alternatively, the inserts 116A and 116B may comprise a two-part epoxy material that is activated and hardens when both parts of the epoxy are exposed to each other. Other examples include, thermosetting materials, UV-setting materials, etc. Several of these inserts 116 are fitted into the opening between the outer and inner pipes 14, 16, recessed at a small distance in from the edge of the outer pipe 16. When the inserts 116 harden, they aggregate into a rigid wall. In an alternative arrangement, one or more polymeric (e.g., rubber or other flexible material) tube-like structures may be amassed within the outer casing, and filled with foam, air, or other material. When the tubes expand, they eliminate the uneven and irregular space between the two pipes 14, 16, and can provide a semi-rigid backing for compression and support of the sealing member 20.

To ensure that the seal assembly 112 will provide sufficient seal strength to withstand an expected pressure buildup within the inner space between the pipes 14, 16, a coating 118 of epoxy or resinous substance can be applied to the backing wall 114. The coating 118 extends from the inner surface 15 of the outer casing 14 to the outer surface 17 of the inner pipe 16, providing a generally complete cover of the backing wall 114. The coating 118 may extend onto the inner and outer surfaces 15, 17, providing a seal once set. In addition, or as an alternative, the resinous/epoxy coating 118 can be applied to the frustoconical segment 24 of the seal body 22 or on the outer surface of the composite wrap 40 (see, e.g., FIGS. 1A-D),.

### Sealing

Once the surface preparation has been completed, a corrosion-prevention sealing putty will be applied within open end of the casing pipe 14. In the embodiment presented in FIG. 3, step 107 includes applying the deformable sealing putty 52 to the outer casing pipe 14, the inner pipe 16, or both at one end of the outer casing pipe 16, and forming the sealing putty 52 into a fluid tight seal that extends between the exterior surface 17 of the inner pipe 16 and the interior surface 15 of the outer casing pipe 14, such as seal member 20 of FIGS. 1A and 1D. It can be desirable to keep the working area dry during application.

In one exemplary application, the sealing putty 52 may be applied (by hand packing or other comparable methods having a similar end-result) to the bottom of the casing pipe 14, working upward to ensure a recommended volume of putty 52 is used. As described above with respect to the end seal annular segment 26 of FIGS. 1A and 1C, the deformable sealing putty 52 may be packed into the casing 14 a distance based on the outer casing ID and the inner pipe OD. To reiterate the above example, a pipeline assembly with a 16 inch (40.64 cm) ID casing pipe and a 12 inch (30.48 cm) OD inner transmission pipe will require the putty 52 be applied at a distance of 2 inches into the open end of the casing 14—i.e., packing depth=2 in or 5.08 cm.

The deformable sealing putty 52 can be used to taper the transition from the casing pipe 14 to the transmission pipeline 16. As explained above with respect to the frustoconical segment 24 of the seal member 20 illustrated in FIGS. 1A and 1C, the taper length L1 is equal to approximately twice the pipeline assembly gap distance D1. In the example presented hereinabove, with an outer casing ID of 16 inches (40.64 cm) and an inner pipe OD of 12 inches (30.48 cm), the taper length L1 of the frustoconical segment 24 is approximately 4 inches (10.16 cm).

### Applying the Structural Composite Wrap:

With continuing reference to the embodiment of FIG. 3, once the deformable sealing putty 52 has been applied and shaped, the end seal composite wrap 54 is applied in step 109. By way of example, each roll of composite wrap is removed from a foil bag or outer container, and briefly inspected to assure that it is soft and pliable, and has not inadvertently preset. In general, the operator may want to open one container bag at a time, and work with one roll of wrap at a time.

During installation, it can be desirable for the composite wrap 54 to be wet on substantially all surfaces. Prior to laying the composite wrap 54, an operator may immerse the fiberglass composite wrap 54 in an open container of water, preferably for at least 30 seconds, while preferably turning and squeezing lightly to wet as much area of the wrap 54 as possible. Alternatively, the composite wrap 54 may be placed over the putty-based seal member 20, and sufficient aqueous moisture be applied thereafter to catalyze the resinous pliable-plastic material contained within the continuous filament fiberglass cloth. Notably, once the composite wrap 54 has been exposed to moisture, there is approximately a 20-30 minute working window within which the wrap 54 must be set, depending upon ambient working temperatures.

The operator may begin the lay up on the putty-based seal member 20, either with each layer directly over the previous layers, or in a spiral bias method with an approximately 50% or so overlap. It is contemplated that the composite wrap 54 be installed smoothly to minimize any unintentional bunching. Moreover, the composite wrap material may be consistently pulled tight, and smoothed from the center out in the direction of the roll. Care can be taken to remove/minimize air spaces and voids between the individual layers of wrap 54. Good adhesion between the layers can be accomplished with consistent pressure and firmly smoothing of the layers with the open palm of the hand in the direction the fiberglass composite wrap 54 is being applied. While applying the wrap 54, it can be desirable for tiny droplets of water to be visibly squeezing through the fiberglass weave of the fiberglass fabric. If there is a lack of such visible droplets, more activating water can be misted over the exposed surfaces of the composite wrap 54 before continuing with wrapping.

The roll of composite wrap 54 can be unwrapped beyond the contact point to ensure correct placement and lay-up. In addition, the composite wrap 54 can be cut in place to eliminate voids or blisters where inconsistent surfaces or obstacles dictate. If the composite wrap 54 is cut, the restarted cut end should overlap the installed end by half the width of the roll. In certain embodiments, a minimum application of eight (8) layers of composite wrap 54 is recommended, although some applications may require fewer or more than 8 layers. In other embodiments more than 15 layers may be required for a particular application, for which a set time of approximately 45 minutes or so may be allowed to lapse between applications of each 15-layer phase.

### Applying the Compression Film:

After the composite wrap 54 has been installed, the end seal assembly 20—i.e., the putty-based seal member 20 encased within the composite wrap 40 seen in FIG. 1B, is wrapped in one or more layers of the elastic compression wrap 56, in step 111. In certain embodiments, the end seal assembly 20 is wrapped in approximately 2-3 layers of compression wrap 56, which is preferably wrapped in the same direction as the composite wrap 40, to achieve a smooth finish and to maintain full contact on the loose ends. As noted above with respect to the embodiment of FIG. 2, the elastic compression wrap 56 can be perforated to allow excess water and any composite wrap by-product gas to escape freely. In general, the perforations may be small holes dispersed throughout the elastic compression wrap 56 (e.g., using the perforator tool 58).

As indicated in step 113, the composite wrap 40 is allowed to dry (i.e., cure) and the elastic compression wrap 56 removed after a predetermined period of time. The composite wrap 54, namely the fiberglass cloth impregnated with a resinous pliable-plastic material, will “out-gas” and bubble for approximately 1-2 hours after installation depending upon temperature; this is a normal part of the curing process. In one example, the composite wrap 40 is allowed to dry for approximately 30 minutes (e.g., at ˜95° F.). In another example, the composite wrap 40 is allowed to dry for approximately 60 minutes (e.g., at ˜75° F.). In yet another example, the composite wrap 40 is allowed to dry for approximately 150 minutes (e.g., at ˜55° F.).

Applying the top coating:

It is contemplated that the fiberglass composite wrap be allowed to properly cure before the topcoat 60 is applied. Once the elastic compression wrap 56 is removed and the composite wrap 54 has cured, the topcoat 60 is applied thereto in step 115, preferably covering and encapsulating the entire end seal assembly 12. The pipeline assembly can buried after 4 hours if applicable.

The method 100 may include at least steps 101-115. However, it is within the scope and spirit of the present invention to omit steps, include additional steps, and/or modify the order presented in FIG. 3. It should be further noted that the method 100 represents a single sequence to create a single end seal assembly. However, it is expected, as indicated above, that the method 100 be applied at both ends of the outer casing 14.

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the claimed invention, which is set forth in the following claims.

1. An end seal assembly for sealing a space between an outer casing and at least one inner pipe extending at least partially through the outer casing, the end seal assembly comprising:
a seal member including a putty material configured to seal the space between the outer casing and the at least one inner pipe, the seal member being in sealing communication with and extending between an exterior surface of the at least one inner pipe and an interior surface of the outer casing; and
a composite wrap covering at least a portion of the seal member.

2. The end seal assembly of claim 1, wherein the putty material comprises a non-cross-linked synthetic polyolefin.

3. The end seal assembly of claim 1, wherein the composite wrap includes a fiberglass composite material comprising a continuous filament fiberglass cloth impregnated with a resinous pliable-plastic material.

4. The end seal assembly of claim 3, wherein the composite wrap is hardened by aqueous moisture.

5. The end seal assembly of claim 1, wherein the composite wrap comprises a plurality of layers of fiberglass composite material.

6. The end seal assembly of claim 1, further comprising a corrosion resistant topcoat covering the seal member and the composite wrap.

7. The end seal assembly of claim 1, wherein the seal member includes a hollow body with a frustoconical segment adjacent to an annular segment.

8. The end seal assembly of claim 7, wherein the frustoconical segment of the seal member has a taper length, and wherein the annular segment has a longitudinal length equal to approximately half of the taper length.

9. The end seal assembly of claim 7, wherein the frustoconical segment of the seal member has a taper length equal to approximately twice the distance between the interior surface of the outer casing and the exterior surface of the at least one inner pipe.

10. The end seal assembly of claim 1, wherein the seal member and the composite wrap cooperatively create a fluid seal configured to withstand a pressure of at least 7 psi within the space between the outer casing and the at least one inner pipe.

11. The end seal assembly of claim 1, further comprising a backing wall within the outer casing, the backing wall generating a semi-rigid surface against which the seal member is compressed.

12. An end seal kit for sealing a space between an outer casing pipe and at least one inner pipe extending at least partially through the outer casing pipe, the end seal kit comprising:
a deformable sealing putty configured to extend between and mate with an exterior surface of the at least one inner pipe and an interior surface of the outer casing pipe to thereby create a fluid tight seal, the sealing putty comprising a non-cross-linked synthetic polyolefin; and
a flexible wrap configured to surround the sealing putty, the flexible wrap comprising a continuous filament fiberglass cloth impregnated with a resinous pliable-plastic material operable to harden upon exposure to aqueous moisture.

13. The end seal kit of claim 12, further comprising an elastic wrap configured to surround the flexible wrap, the elastic wrap comprising a perforable film.

14. The end seal kit of claim 13, further comprising a perforator tool configured to puncture the perforable film to thereby generate a plurality of perforations in the elastic wrap.

15. The end seal kit of claim 12, further comprising a corrosion resistant topcoat configured to cover substantially all of the flexible wrap.

16. A method for sealing a space between an outer casing pipe and at least one inner pipe extending at least partially through the outer casing pipe, the method comprising:
applying a deformable sealing putty to at least one of the outer casing pipe and the at least one inner pipe;
forming the sealing putty into a fluid tight seal extending between an exterior surface of the inner pipe and an interior surface of the outer casing pipe, the seal having a seal body with an annular segment disposed within the casing pipe and a frustoconical segment extending generally coaxial from one side of the annular segment outside of the outer casing pipe;
wrapping a flexible composite wrap around the frustoconical segment of the seal; and
curing the flexible composite wrap.

17. The method of claim 16, wherein the flexible composite wrap comprises a continuous filament fiberglass cloth impregnated with a resinous pliable-plastic material operable to harden upon exposure to aqueous moisture.

18. The method of claim 17, wherein the curing the flexible fiberglass composite wrap includes applying aqueous moisture to the flexible fiberglass composite wrap, and allowing the flexible fiberglass composite wrap to dry for a predetermined period of time.

19. The method of claim 16, further comprising wrapping an elastic compression wrap around the flexible composite wrap.

20. The method of claim 19, wherein the elastic compression wrap comprises a perforable film.

21. The method of claim 20, further comprising puncturing the perforable film to thereby generate a plurality of perforations in the elastic compression wrap.

22. The method of claim 19, further comprising:
removing the elastic compression wrap; and
applying a corrosion resistant topcoat over substantially all of the flexible wrap and at least portions of the at least one inner pipe and the casing pipe.

23. The method of claim 16, further comprising creating an anchor pattern in at least a portion of the interior surface of the outer casing pipe and the exterior surface of at least one inner pipe prior to the applying the deformable sealing putty to the outer casing pipe and the inner pipe.

24. The method of claim 16, wherein the wrapping the flexible composite wrap includes wrapping a plurality of flexible fiberglass composite wraps around the frustoconical segment of the seal.

25. The method of claim 24, further comprising applying pressure to the plurality of flexible fiberglass composite wraps to thereby eliminate voids between respective ones of the plurality of flexible fiberglass composite wraps.

26. The method of claim 16, further comprising;
excavating the outer casing pipe and the at least one inner pipe; and
checking the outer casing pipe and the at least one inner pipe for any of an array of predetermined deterioration characteristics prior to applying the deformable sealing putty.

27. The method of claim 26, wherein the predetermined deterioration characteristics include at least one of significant wall loss and significant pipe contact.

28. The method of claim 16, wherein the frustoconical segment of the seal has a taper length, and the annular segment has a longitudinal length equal to approximately half of the taper length.

29. The method of claim 16, wherein the frustoconical segment of the seal has a taper length equal to approximately twice the distance between the interior surface of the outer casing and the exterior surface of the at least one inner pipe.

30. The method of claim 16, further comprising:
creating a rigid backing wall within the outer casing; and
compressing the deformable sealing putty against the rigid backing wall.
